(19) United States
(12) Patent Application Publication
(10) Pub. No.: US 2008/0227621 A1
(43) Pub. Date: Sep. 18, 2008

(54) Glass capable of emitting infrared rays

(76) Inventor: Hsin-Mao Hsieh, Pingtung City (TW)

Correspondence Address: ANDREWS KURTH LLP, 1350 I STREET, N.W., SUITE 1100, WASHINGTON, DC, 20005, US

(21) Appl. No.: 11/717,206

(22) Filed: Mar. 13, 2007

(51) Int. Cl. C03C 3/04

(52) U.S. Cl. 501/135

(57) ABSTRACT

A glass includes SiO₂, Na₂CO₃, K₂CO₃, CaO and ceramic particles which is composed of a combination of ALO₃, MgO, and ZrO₂ to emit infrared rays.

### BACKGROUND OF THE INVENTION

1. Field of the Invention

The present invention relates to a piece of glass, and more particularly to a piece of glass capable of emitting infrared rays.

2. Description of the Prior Art

Infrared light rays is an electromagnetic wave with wavelength of 4-14 nm (nano-meter), which is able to penetrate the human skin up to 5˜10 mm to resonance with tissue molecular. This phenomenon is clinically proved to be effective to active the human tissue, improve blood circulation, metabolism, remove odor . . . etc . . . . Because of these miraculous effects to human health, a lot of products capable of emitting infrared rays are introduced to the market to improve human health so that no matter the user is wearing the product or living in an environment full of infrared rays emitted by products surrounding the user, the user benefits from the products.

Looking at the products available in the market, none of which are made of glass. Most of the products already introduced to the market are made of fabrics or related to fabric made products. Therefore, if a product made of glass and capable of emitting infrared rays is introduced to the market, people's health will be greatly improved.

To overcome the shortcomings concerning lack of products made of glass and capable of emitting infrared rays, the present invention tends to provide an improved glass to mitigate the aforementioned problems.

### SUMMARY OF THE INVENTION

The primary objective of the present invention is to provide a glass which is able to emit infrared rays.

In order to accomplish the aforementioned objective, the glass is composed of SiO₂, Na₂CO₃, K₂CO₃, CaO and ceramic particles composed of ALO₃, MgO, ZrO₂, TiO₂, and SiO₂ Due to the combination of ALO₃, MgO, ZrO_{2,}, TiO₂, and SiO₂ being able to emit infrared rays, the glass is able to emit infrared rays.

Other objects, advantages and novel features of the invention will become more apparent from the following detailed description when taken in conjunction with the accompanying drawings.

### BRIEF DESCRIPTION OF THE DRAWINGS

FIG. 1 is a cross sectional view of the glass of the present invention;

FIG. 2 is a cross sectional view of a marble made of the glass of the present invention;

FIG. 3 is a side plan view showing the application of the glass of the present invention in a different marble;

FIG. 4 is schematic view showing that the glass of the present invention is implemented in a car; and

FIG. 5 is a schematic view showing that the glass of the present invention is implemented in a window.

### DETAILED DESCRIPTION OF THE PREFERRED EMBODIMENT

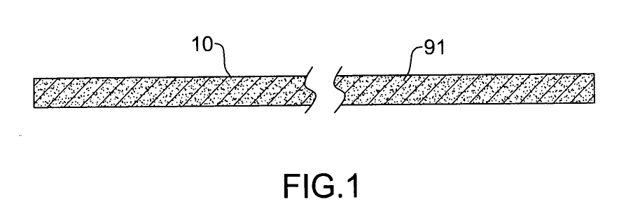

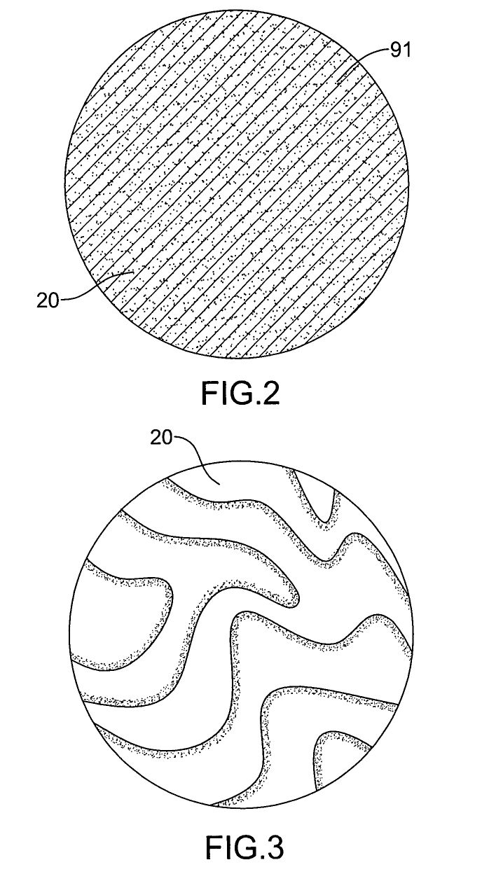

With reference to FIGS. 1 and 2, it is noted that the glass in accordance with the present invention includes a body (10,20) having therein ceramic particles (91).

In natural resources, several mines are found to be able to emit infrared rays with 4-14nm wavelength. Each of the mines generally is composed of ALO₃, MgO, ZrO_{2,}, TiO₂, and SiO₂. Because the ceramic particles (91) inside the body (10,20) of the glass of the present invention contains ALO₃, MgO, ZrO_{2,}, TiO₂, and SiO₂, the glass of the present invention is also able to emit infrared rays. And the higher the temperature of the glass is, the stronger energy the infrared rays will become.

The ceramic particles (91) are added to the process of forming the glass which is normally composed of SiO₂, Na₂CO₃, K₂CO₃, CaO. Thus in the molten combination of SiO₂, Na₂CO₃, K₂CO₃, CaO, adding the combination of ALO₃, MgO, ZrO_{2,}, TiO₂, and SiO₂ becomes very easy in that a same component (SiO₂) exists in both compound. Therefore, after curing the glass of the present invention, the combination of ALO₃, MgO, ZrO_{2,}, TiO₂ is evenly distributed inside the glass to enable the glass to emit infrared rays.

With reference to FIG. 3, it is noted that the glass of the present invention may be implemented in the body (20) of a different type of marble which is made solely for decoration and/or collection. As a result, when the user is wearing the marble as shown in FIG. 3, the constant emission of infrared rays enables to active cell tissues, improve blood circulation and metabolism.

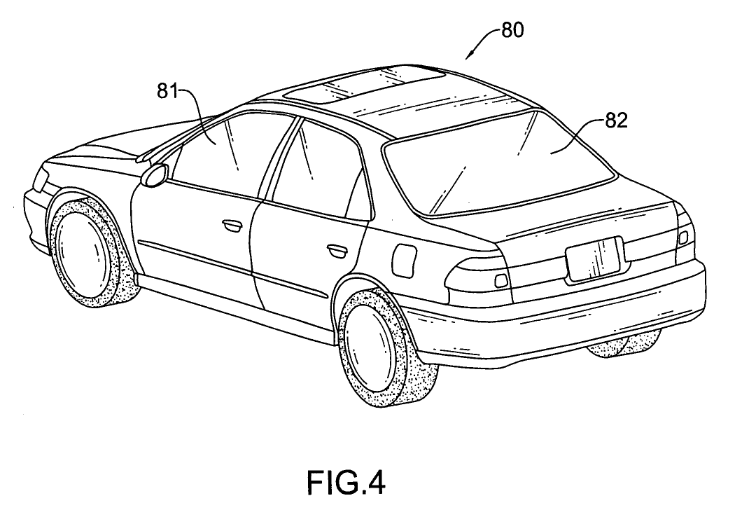

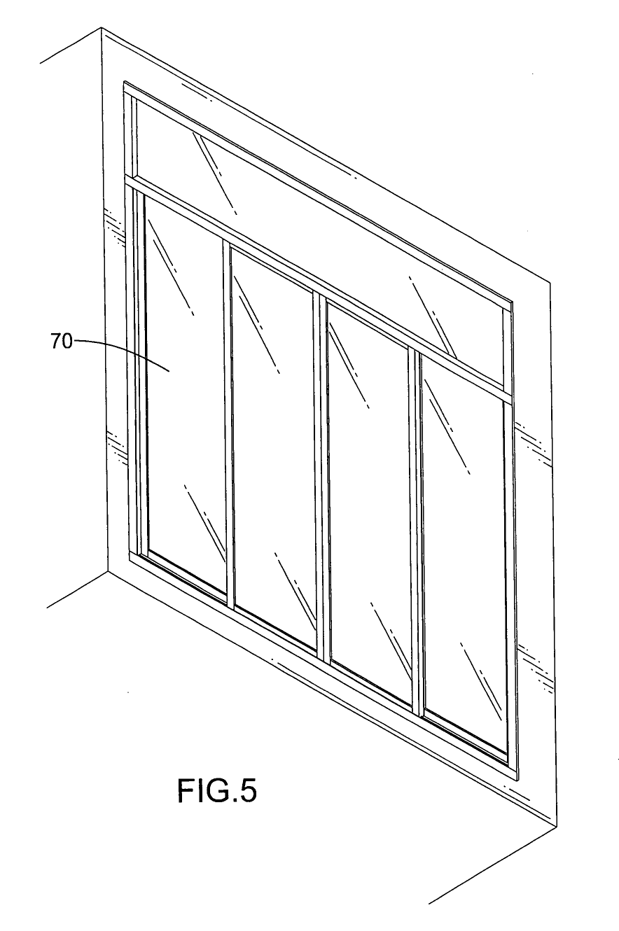

With reference to FIG. 4, it is noted that the glass of the present invention may also be implemented in windows of a car (80), which includes the front window, side windows (81) and the rear window (82). After all the windows of the car (80) are made of the glass of the present invention, the driver sitting behind the steering wheel is surrounded by infrared rays coming from all directions. Thus the longer the driver sitting inside the car, the health improving effect is more prominent.

With reference to FIG. 5, it is noted that the glass of the present invention may be implemented in a window (70) inside a house such that after the ceramic particles (91), as shown in FIG. 1, is evenly distributed in the glass of which the window (70) is made, the person living inside the house will be constantly surrounded by the infrared rays and the person's health is greatly improved.

In addition, each of the ceramic particles has a diameter of nano-meter so that they are invisible by human eyes and have very little affect in blocking the sun light.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A glass consisting essentially of SiO₂, Na₂CO₃, K₂CO₃, CaO and ceramic particles which is composed of a combination of ALO₃, MgO, and ZrO₂ capable of emitting infrared rays.

2. The glass as claimed in claim 1, wherein each of the ceramic particles has a diameter of nano-meter.
